(19) United States
(12) Patent Application Publication
(10) Pub. No.: US 2024/0108529 A1
(43) Pub. Date: Apr. 4, 2024

(54) PORTABLE TRAINING DEVICE FOR PLANTAR CORE MUSCLES

(71) Applicant: TZU CHI UNIVERSITY, HUALIEN COUNTY (TW)

(72) Inventors: CHICH-HAUNG YANG, HUALIEN COUNTY (TW); YUNG-JENG SHIAU, HUALIEN COUNTY (TW); SHENG-LUN KAO, HUALIEN COUNTY (TW)

(21) Appl. No.: 18/347,063

(22) Filed: Jul. 5, 2023

(30) Foreign Application Priority Data
Oct. 3, 2022 (TW) 111137537

(51) Int. Cl. A61H 1/02

(52) U.S. Cl. CPC A61H 1/0266; A61H 2201/0134; A61H 2205/12

(57) ABSTRACT

A portable training device for plantar core muscles includes: a supporting portion corresponding in position to a transverse arch of a human sole and having a supporting-portion thickness and an allowable deformation in a Z direction; an inner cushioning portion connected to the supporting portion, corresponding in position to a first metatarsophalangeal joint of the sole, and having an inner-cushioning-portion thickness in the Z direction; and an outer cushioning portion connected to the supporting portion, corresponding in position to a fifth metatarsophalangeal joint of the sole, and having an outer-cushioning-portion thickness in the Z direction. The supporting-portion thickness is greater than the inner- and the outer-cushioning-portion thicknesses. When the portable training device is stepped on with the sole, the supporting portion supports the transverse arch to help train a longitudinal arch of the sole to arch naturally, thereby guiding the plantar core muscles into contraction to strength those muscles.

### BACKGROUND OF THE INVENTION

### 1. Technical Field

The present invention relates to a portable training device for plantar core muscles. More particularly, the invention relates to a training device for developing the strength of the plantar core muscles of a foot by allowing the user to exert a downward force through the metatarsophalangeal joints of the foot and press a transverse arch of the foot against a supporting portion such that a longitudinal arch of the foot arches naturally to induce contraction of the plantar core muscles.

### 2. Description of Related Art

In “The foot core system: a new paradigm for understanding intrinsic foot muscle function” published in the British Journal of Sports Medicine in 2015, Patrick O. McKeon et al. put forward the concept that a sole has core muscles analogous to those of a torso. When the curvatures of the foot arches and the control of the curvatures become abnormal, the lower extremities tend to move in an erroneous compensatory mode, causing pain or injury to the affected joints and body parts.

The muscles of a foot include the intrinsic core muscles (which are responsible for stabilization and for providing sensory functions and internal movements) and the extrinsic muscles (which are responsible for providing relatively large movements). More specifically, the core muscles include: (1) abductor halluces, (2) flexor digitorum brevis, (3) abductor digiti minimi, (4) quadratus plantae, (5) lumbricals, (6) flexor digiti minimi, (7) adductor hallucis oblique, (8) flexor hallucis brevis, (9) plantar interossei, (10) dorsal interossei, and (11) extensor digitorum brevis.

Conventionally, basic foot training includes the typical exercise of grabbing a towel with toes. However, bending the toes requires movements of only the external muscles of the sole, and it is difficult to train the deeper plantar core muscles with such an exercise. To train the plantar core muscles properly, it is important to refrain from bending the toes, and the longitudinal foot arches should arch naturally without being supported by an external object. Only in this state can the plantar core muscles be trained to develop greater strength.

Clinically, the training concept of short foot exercise is applied to strengthening the plantar core muscles. More specifically, the longitudinal arches of a foot are raised by bringing the front part of the sole and the heel closer toward each other without force exertion by the toes, the objective being to guide the plantar core muscles into contraction and thereby train the plantar core muscles to develop greater strength. Such a training method is nevertheless difficult because a beginner may have problem applying the required force in the required manner and end up bending the toes (i.e., applying a force through the toes alone) without raising the longitudinal arches; consequently, the training result leaves much to be desired.

Published Taiwan Patent Application No. TW200611682A, entitled “THE INDUCER OF AN ARCH OF FOOT”, discloses a centrally raised base board whose top surface is provided with three-dimensional pillars of irregular shapes and heights. A plurality of such base boards can be laid on the floor or the ground to form a bumpy ground surface for stimulating, and thereby training, the plantar muscles. This training method, however, involves only placing a foot on the bumpy ground surface to increase the height of a foot arch. The training method does not guide the core muscles of the foot into active force exertion. The training result is therefore unsatisfactory.

Taiwan Patent No. 1693952, entitled “TRAINING DEVICE AND METHOD FOR PLANTAR CORE MUSCLES”, discloses a bottom board provided with a strap and a dragging rod. The dragging rod is disposed at a front part of the bottom board, and the strap is disposed at the middle of the bottom board. In use, the dragging rod corresponds in position to the metatarsal bones of a foot while the strap is strapped over the instep. When the dragging rod is stepped on with the foot in such a way that the heel presses against the bottom board and the instep is strapped, and thus limited in position, by the strap, a longitudinal arch of the foot will arch naturally to induce contraction of, and thereby train, the plantar core muscles. This training method, however, must be carried out at a fixed location. Not only is it impossible to perform training by wearing the training device, but also the bulkiness of the training device makes it difficult to carry the training device around.

### BRIEF SUMMARY OF THE INVENTION

In view of the above, the inventor of the present invention provides a plantar core muscle training device that is portable to allow plantar core muscles to be trained wherever or whenever desired, and that trains the plantar core muscles of a foot by providing support for a transverse arch of the foot and thereby guiding a longitudinal arch of the foot to arch naturally. The portable training device for plantar core muscles is configured for use by a human sole. The sole has a transverse direction defined as an X direction and a longitudinal direction defined as a Y direction, and a Z direction is perpendicular to both the X direction and the Y direction. The sole includes a first metatarsophalangeal joint, a fifth metatarsophalangeal joint, and a heel. A transverse arch of the sole is defined between the first metatarsophalangeal joint and the fifth metatarsophalangeal joint, and a longitudinal arch of the sole is defined between the first metatarsophalangeal joint and the heel. The portable training device for plantar core muscles includes a supporting portion, an inner cushioning portion, and an outer cushioning portion. The supporting portion is configured to be disposed at a portion corresponding to the transverse arch. The supporting portion has a supporting-portion thickness in the Z direction. The supporting portion further has an allowable deformation in the Z direction. The inner cushioning portion is connected to the supporting portion. The inner cushioning portion is configured to be disposed at a position corresponding to the first metatarsophalangeal joint. In addition, the inner cushioning portion has an inner-cushioning-portion thickness in the Z direction. The outer cushioning portion is connected to the supporting portion too. The outer cushioning portion is configured to be disposed at a position corresponding to the fifth metatarsophalangeal joint. Moreover, the outer cushioning portion has an outer-cushioning-portion thickness in the Z direction. The supporting-portion thickness is greater than the inner-cushioning-portion thickness and the outer-cushioning-portion thickness. When the portable training device for plantar core muscles is stepped on with the sole, the supporting portion supports the transverse arch to help train the longitudinal arch to arch naturally, the objective being to guide the plantar core muscles of the sole into contraction so that the plantar core muscles can develop greater strength.

Preferably, the allowable deformation is one third to one half of the supporting-portion thickness.

Preferably, the supporting portion includes a supporting-portion upper surface, the supporting-portion upper surface is configured to contact the transverse arch, and the supporting-portion upper surface is a curved surface corresponding to the transverse arch.

Preferably, the supporting portion has a major axis defining the greatest length of the supporting portion in the Y direction, the supporting portion further has a minor axis defining the greatest length of the supporting portion in the X direction, and the length of the major axis is greater than that of the minor axis.

Preferably, the major axis and the Y direction form a first angle, and the first angle is in the range from −15 degrees to +15 degrees. Preferably, the inner cushioning portion has an inner-cushioning-portion geometric center, the outer cushioning portion has an outer-cushioning-portion geometric center, the line connecting the outer-cushioning-portion geometric center and the inner-cushioning-portion geometric center is defined as a geometric center connecting line, the geometric center connecting line and the X direction form a second angle, and the second angle is in the range from 15 degrees to 35 degrees.

Preferably, the inner cushioning portion has an inner-cushioning-portion upper surface, and the inner-cushioning-portion upper surface is concave.

Preferably, the inner cushioning portion is circular and is provided with a plurality of annular portions of different diameters, and these annular portions are arranged at intervals along a radial direction.

Preferably, the outer cushioning portion has an outer-cushioning-portion upper surface, and the outer-cushioning-portion upper surface is concave.

Preferably, the outer cushioning portion is circular and is provided with a plurality of annular portions of different diameters, and these annular portions are arranged at intervals along a radial direction.

Preferably, the length of the major axis is in the range from 25 mm to 60 mm, the length of the minor axis is in the range from 15 mm to 40 mm, the inner-cushioning-portion thickness is in the range from 5 mm to 10 mm, the outer-cushioning-portion thickness is in the range from 5 mm to 10 mm, the supporting-portion thickness is in the range from 12 mm to 20 mm, the outermost edges of the inner cushioning portion and of the outer cushioning portion in the X direction define a width in the X direction that is in the range from 40 mm to 120 mm, and the outermost edges of the inner cushioning portion and of the outer cushioning portion in the Y direction define a length in the Y direction that is in the range from 30 mm to 80 mm.

Preferably, the portable training device for plantar core muscles further includes an elastic plate, the elastic plate has an elastic-plate main body, the supporting portion encloses the elastic-plate main body, the elastic plate has elasticity in the Z direction, and the allowable deformation of the supporting portion is made possible by the elasticity.

Preferably, the elastic-plate main body has two lateral sides extended with an inner wing plate and an outer wing plate respectively, the inner cushioning portion encloses the inner wing plate, and the outer cushioning portion encloses the outer wing plate.

The foregoing technical features can produce the following effects:

1. The first metatarsophalangeal joint, the fifth metatarsophalangeal joint, and the transverse arch of the sole press against, and are comfortably supported by, the portable training device for plantar core muscles when the portable training device for plantar core muscles is stepped on with the sole. The support provided to the sole by the curved surface of the supporting portion makes it easier to train the transverse arch and the longitudinal arch of the sole to arch naturally without bending the toes, and to thereby guide the plantar core muscles into contraction in order for the plantar core muscles to develop greater strength. Moreover, in the course in which the longitudinal arch arches, the transverse arch will be well cushioned and feel comfortable thanks to deformation of the supporting portion.

2. The portable training device for plantar core muscles can be worn on a foot along with a sock and will lie compliantly on the sole, with the supporting portion providing dynamic support during use. This allows a user to train the plantar core muscles wherever and whenever desired and have a better training result than achievable with the prior art.

3. The portable training device for plantar core muscles can also be placed on the ground or any other flat surface or be adhesively attached to the sole of a shoe. When two such portable training devices are used, the user can step on the portable training devices with both feet to practice arching the transverse and longitudinal arches, and thereby train the plantar core muscles, of both feet.

4. When the first metatarsophalangeal joint and the fifth metatarsophalangeal joint of the sole press against the inner cushioning portion and the outer cushioning portion respectively, the concave inner-cushioning-portion upper surface and the concave outer-cushioning-portion upper surface lie compliantly on the sole at positions corresponding to the first metatarsophalangeal joint and the fifth metatarsophalangeal joint, and this allows the portable training device for plantar core muscles to be worn comfortably.

### BRIEF DESCRIPTION OF THE SEVERAL VIEWS OF THE DRAWINGS

FIG. 1 is a perspective view of the first embodiment of the present invention.

FIG. 2 schematically shows the first embodiment of the present invention stepped on with a sole and how the first embodiment corresponds in position to the sole.

FIG. 3 is a top view of the first embodiment of the present invention.

FIG. 4 is a front view of the first embodiment of the present invention.

FIG. 5 is a sectional view of the first embodiment of the present invention.

FIG. 6 schematically shows the forces applied when the first embodiment of the present invention is stepped on with a sole.

FIG. 7 is another schematic drawing showing the forces applied when the first embodiment of the present invention is stepped on with a sole.

FIG. 8 is a perspective view of the second embodiment of the present invention.

FIG. 9 is a top view of the second embodiment of the present invention.

FIG. 10 is a sectional view of the second embodiment of the present invention.

### DETAILED DESCRIPTION OF THE INVENTION

The foregoing technical features are incorporated into the portable training device of the present invention for plantar core muscles, and the major functions of the portable training device can be clearly known from the embodiments described below.

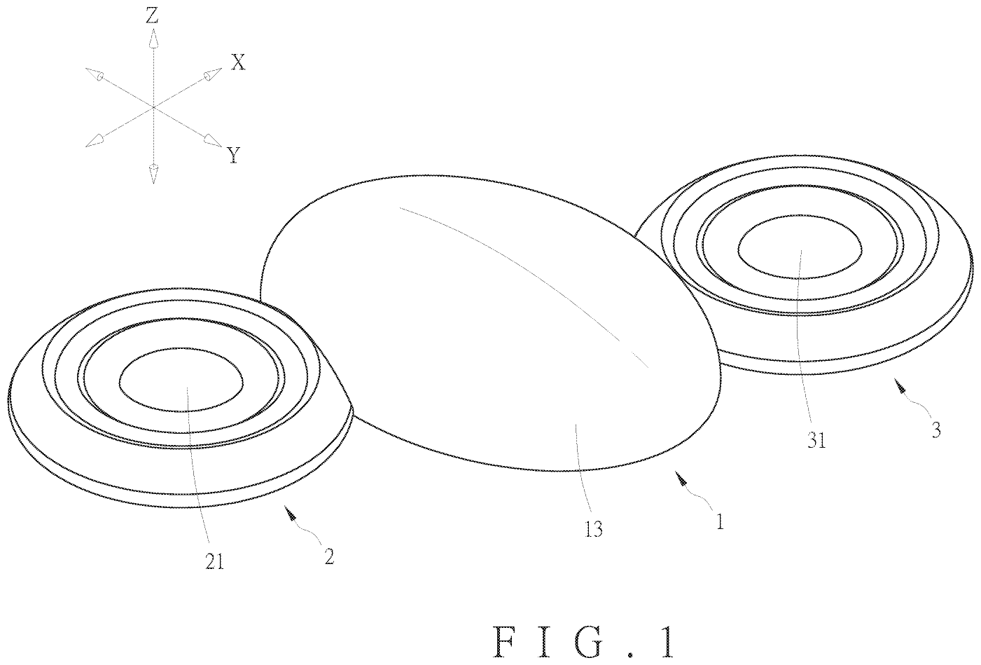

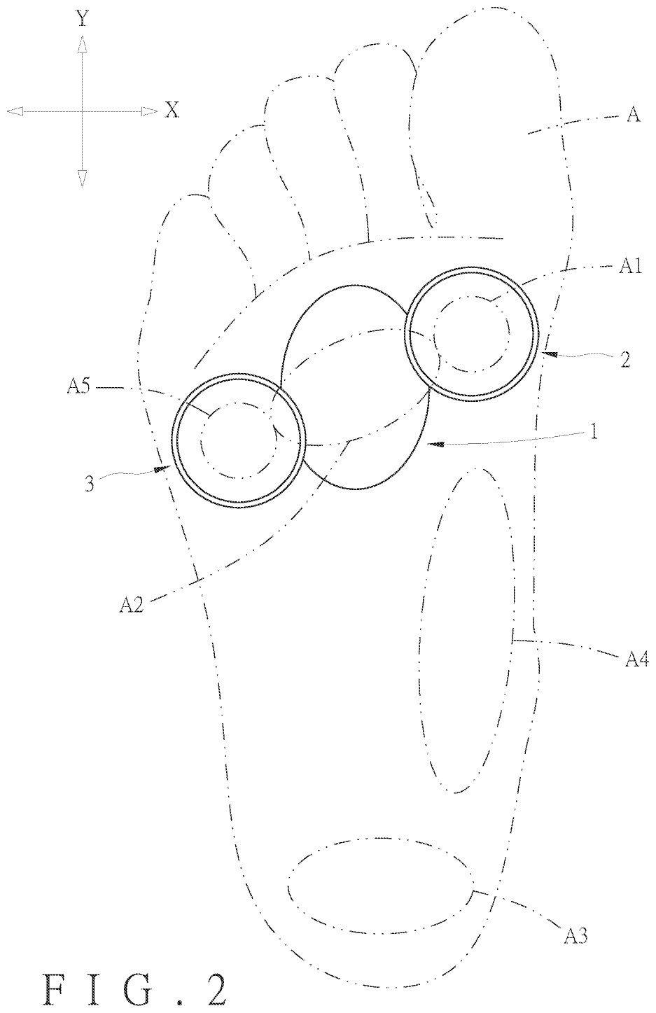

Referring to FIG. 1 and FIG. 2, the portable training device of the present invention for plantar core muscles is configured for use by a human sole A. The sole A has a horizontal, or transverse, direction defined as an X direction and a vertical, or longitudinal, direction defined as a Y direction. A Z direction is perpendicular to both the X direction and the Y direction. The sole A includes a first metatarsophalangeal joint A1, a fifth metatarsophalangeal joint A5, and a heel A3. A transverse arch A2 of the sole A is defined between the first metatarsophalangeal joint A1 and the fifth metatarsophalangeal joint A5, and a longitudinal arch A4 of the sole A is defined between the first metatarsophalangeal joint A1 and the heel A3. The portable training device for plantar core muscles includes a supporting portion 1, an inner cushioning portion 2, and an outer cushioning portion 3.

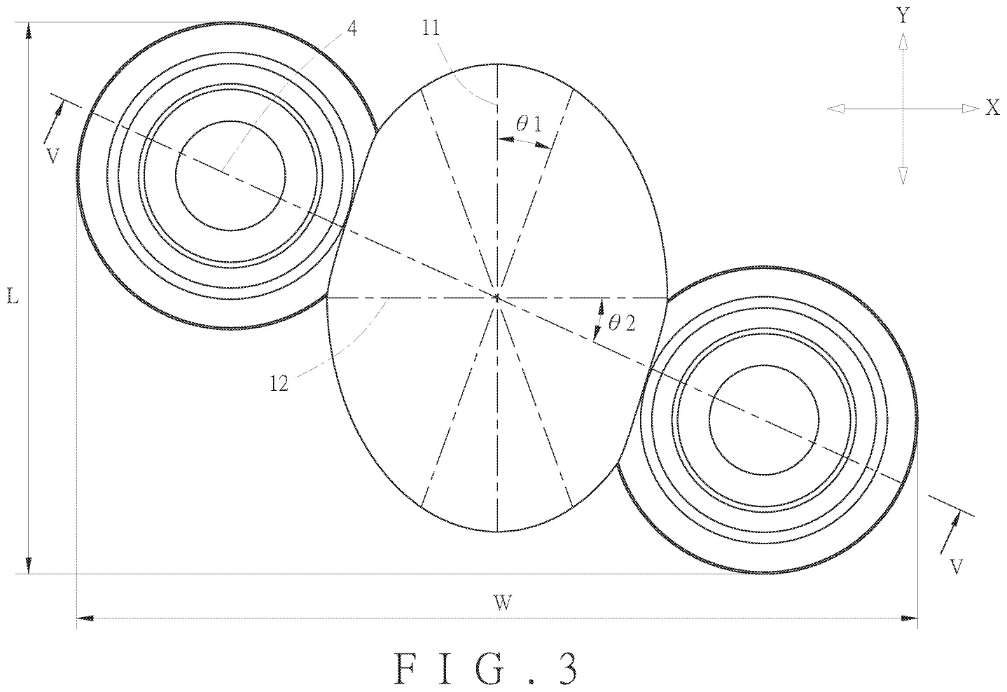

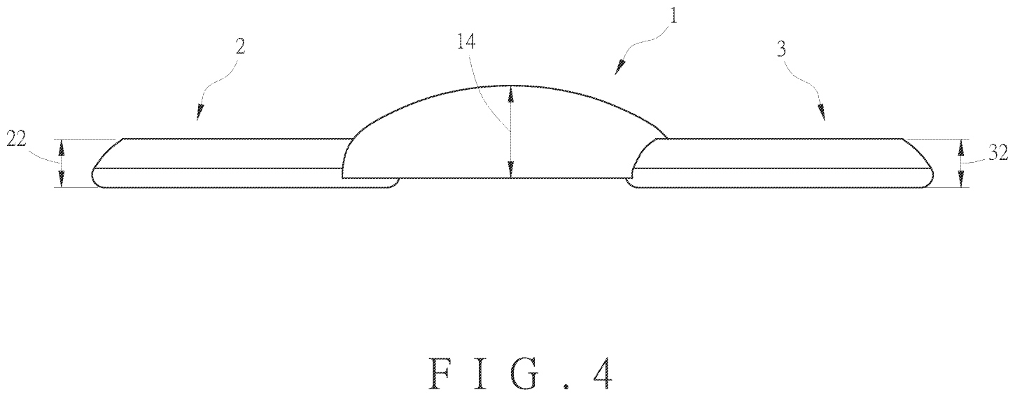

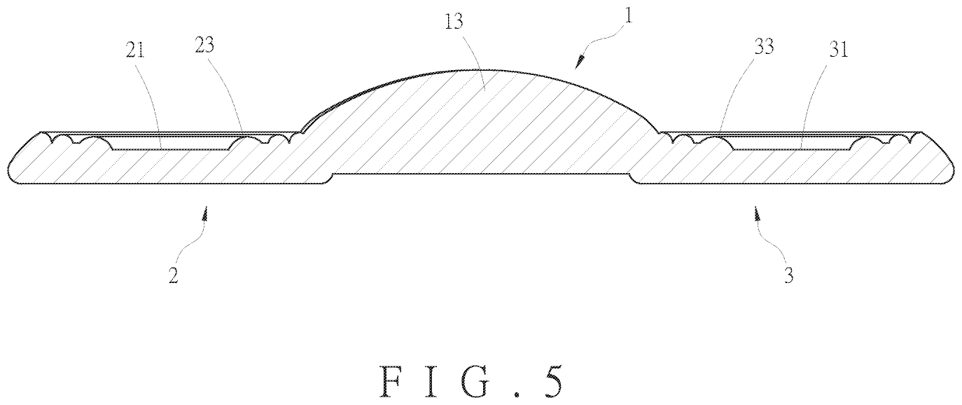

In the first embodiment, referring to FIG. 2, FIG. 3, FIG. 4, and FIG. 5, the supporting portion 1 is configured to be disposed at a position corresponding to the transverse arch A2. The supporting portion 1 extends along the Y direction, and the supporting portion 1 has a major axis 11 defining the greatest length of the supporting portion 1 in the Y direction. The supporting portion 1 also extends along the X direction, and the supporting portion 1 has a minor axis 12 defining the greatest length of the supporting portion 1 in the X direction. The supporting portion 1 further has a supporting-portion geometric center. The supporting portion 1 includes a supporting-portion upper surface 13, and the supporting-portion upper surface 13 is configured for contact with the transverse arch A2 and is a curved surface corresponding to the transverse arch A2. In addition, the supporting portion 1 has a supporting-portion thickness 14 in the Z direction. The supporting portion 1 also has an allowable deformation in the Z direction, and the allowable deformation is one third to one half of the supporting-portion thickness 14. To match the sole sizes of adults, children, males, and females, the length of the major axis 11 may range from 25 mm to 60 mm, and the length of the minor axis 12 may range from 15 mm to 40 mm, with the length of the major axis 11 being greater than that of the minor axis 12. Moreover, the supporting-portion thickness 14 at the supporting-portion geometric center may range from 12 mm to 20 mm. The major axis 11 and the Y direction form a first angle θ1, and the first angle θ1 may range from −15 degrees to +15 degrees. The first angle θ1 in this embodiment is 0 degree.

The inner cushioning portion 2 is connected to the supporting portion 1. The inner cushioning portion 2 is configured to be disposed at a position corresponding to the first metatarsophalangeal joint A1. The inner cushioning portion 2 has an inner-cushioning-portion geometric center and has an inner-cushioning-portion upper surface 21 corresponding to the first metatarsophalangeal joint A1, wherein the inner-cushioning-portion upper surface 21 is concave. The inner cushioning portion 2 further has an inner-cushioning-portion thickness 22 in the Z direction. The projection of the inner cushioning portion 2 on an XY plane defined by the X direction and the Y direction has a circular shape, and in order to adapt to different sole sizes, the diameter of this circular shape may range from 15 mm to 40 mm. Also, the inner cushioning portion 2 is provided with a plurality of annular portions 23 of different diameters, and the annular portions 23 are arranged at intervals in a radial direction of the circular shape. The inner-cushioning-portion thickness 22 may range from 5 mm to 10 mm.

The outer cushioning portion 3 is connected to the supporting portion 1. The outer cushioning portion 3 is configured to be disposed at a position corresponding to the fifth metatarsophalangeal joint A5. The outer cushioning portion 3 has an outer-cushioning-portion geometric center and has an outer-cushioning-portion upper surface 31 corresponding to the fifth metatarsophalangeal joint A5, wherein the outer-cushioning-portion upper surface 31 is concave. The outer cushioning portion 3 further has an outer-cushioning-portion thickness 32 in the Z direction. The supporting-portion thickness 14 is greater than the inner-cushioning-portion thickness 22 and the outer-cushioning-portion thickness 32. The projection of the outer cushioning portion 3 on the XY plane defined by the X direction and the Y direction has a circular shape, and in order to adapt to different sole sizes, the diameter of this circular shape may range from 15 mm to 40 mm. Also, the outer cushioning portion 3 is provided with a plurality of annular portions 33 of different diameters, and the annular portions 33 are arranged at intervals in a radial direction of the circular shape. The outer-cushioning-portion thickness 32 may range from 5 mm to 10 mm.

The line connecting the outer-cushioning-portion geometric center and the inner-cushioning-portion geometric center is defined as a geometric center connecting line 4. The geometric center connecting line 4 and the X direction form a second angle θ2, and in order to adapt to different sole sizes, the second angle θ2 may range from 15 degrees to 35 degrees. The second angle θ2 in this embodiment is 20 degrees. The outermost edges of the inner cushioning portion 2 and of the outer cushioning portion 3 in the X direction define a width W along the X direction that may range from 40 mm to 120 mm. The outermost edges of the inner cushioning portion 2 and of the outer cushioning portion 3 in the Y direction define a length L along the Y direction that may range from 30 mm to 80 mm.

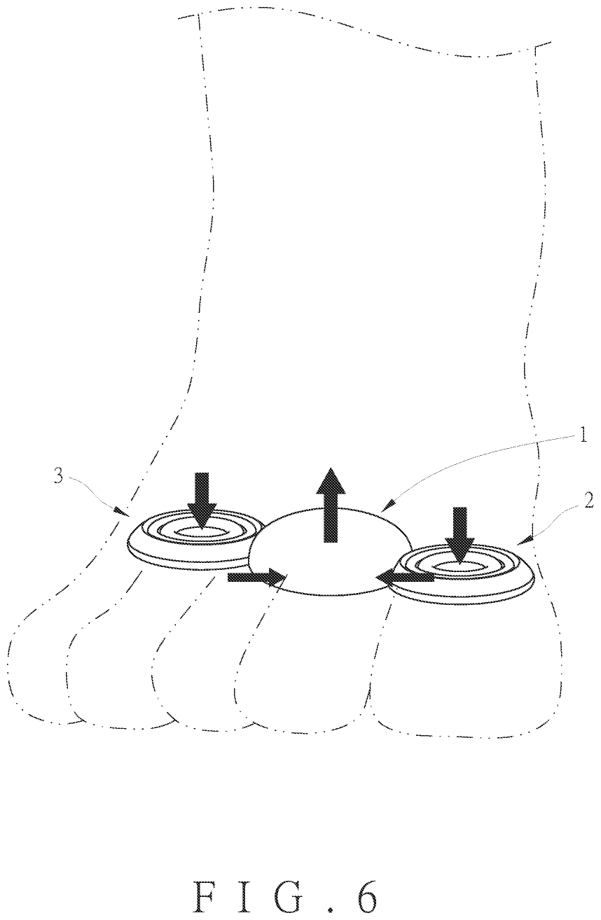

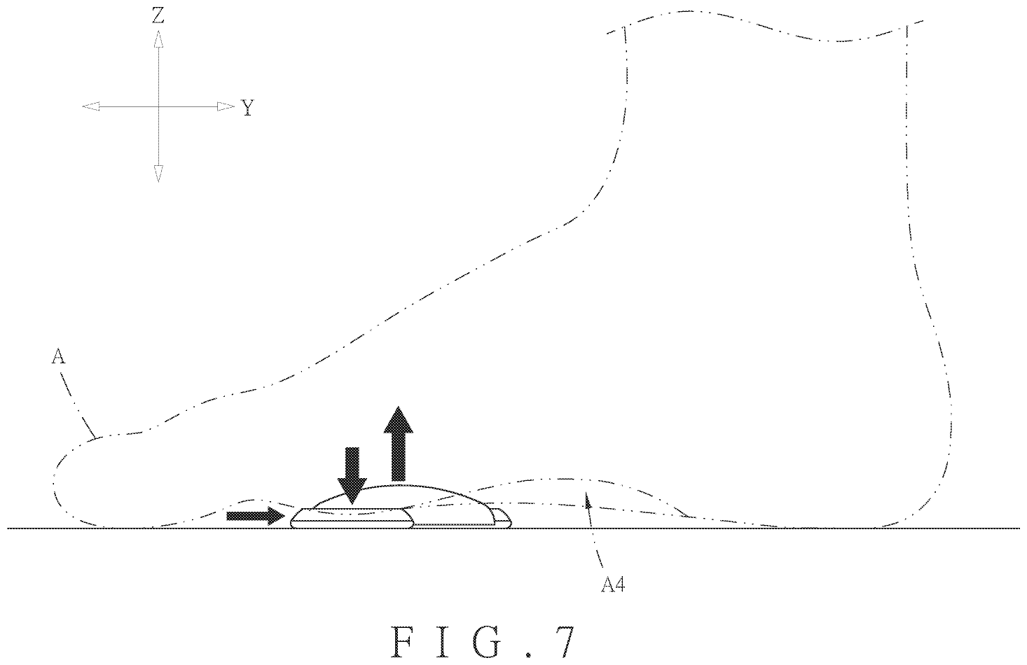

Referring to FIG. 2, FIG. 6, and FIG. 7, the portable training device of the present invention for plantar core muscles can be worn on a foot along with a sock or be placed on any flat surface such as the ground or an insole in order to be used; all of the above are possible scenarios of use. When the portable training device for plantar core muscles is placed on an insole or is worn on a foot together with a sock, the user will be able to train themselves to arch the longitudinal arch, and thereby strengthen the plantar core muscles, whenever desired while riding in a car or otherwise seated; in other words, it is not necessary to perform the training at a fixed location at home.

When the portable training device of the present invention for plantar core muscles is stepped on with the sole A, the transverse arch A2 presses against the supporting portion 1, the first metatarsophalangeal joint A1 applies a downward force to, and thereby presses down on, the inner cushioning portion 2, and the fifth metatarsophalangeal joint A5 applies a downward force to, and thereby presses down on, the outer cushioning portion 3. As the upper surface of the supporting portion 1 (i.e., the supporting-portion upper surface 13) is a convex surface, the user's first metatarsophalangeal joint A1 and fifth metatarsophalangeal joint A5 will be guided closer toward each other in the transverse direction, i.e., in the directions indicated by the two transverse arrows in FIG. 6 respectively, and this allows the user to arch, i.e., to increase the height of, the transverse arch A2 as indicated by the upward arrow in FIG. 6 and thus guide the plantar core muscles to contract. In addition, referring to FIG. 6 and FIG. 7, with the first metatarsophalangeal joint A1 applying a downward force to, and thereby pressing down on, the inner cushioning portion 2, and the fifth metatarsophalangeal joint A5 applying a downward force to, and thereby pressing down on, the outer cushioning portion 3, the convex surface of the supporting portion 1 helps the user arch the longitudinal arch A4 easily and naturally as shown in FIG. 7, and the arching of the longitudinal arch A4 will guide the plantar core muscles to contract, too. The support provided by the supporting portion 1 to the plantar transverse arch A2 makes it easier for the user to arch the transverse arch A2 and the longitudinal arch A4 without bending the toes during the training process, so the plantar core muscles of the sole A can be guided into contraction and thereby trained to develop greater muscle strength. More specifically, while the sole A is being trained, the two end portions of the sole A that correspond respectively to the first metatarsophalangeal joint A1 and the fifth metatarsophalangeal joint A5 apply a downward force such that the transverse arch A2, which lies between the first metatarsophalangeal joint A1 and fifth metatarsophalangeal joint A5, presses against the supporting portion 1 to help arch the longitudinal arch A4 naturally without bending the toes. By training the longitudinal arch A4 to arch naturally, the plantar core muscles are also guided into contraction such that the objective of training the plantar core muscles is achieved. When the sole A exerts the foregoing force in the way described above, the toes corresponding to the sole A will not exert any force or bend, and this prevents the external muscle movements otherwise required to control the toes from being induced, ensuring that the plantar core muscles are trained through active and correct force application. Moreover, the portable training device of the invention for plantar core muscles can be placed on an insole or worn on a foot along with a sock so that when the user is moving, the supporting portion 1 can provide dynamic support for the sole to greatly enhance the training effect.

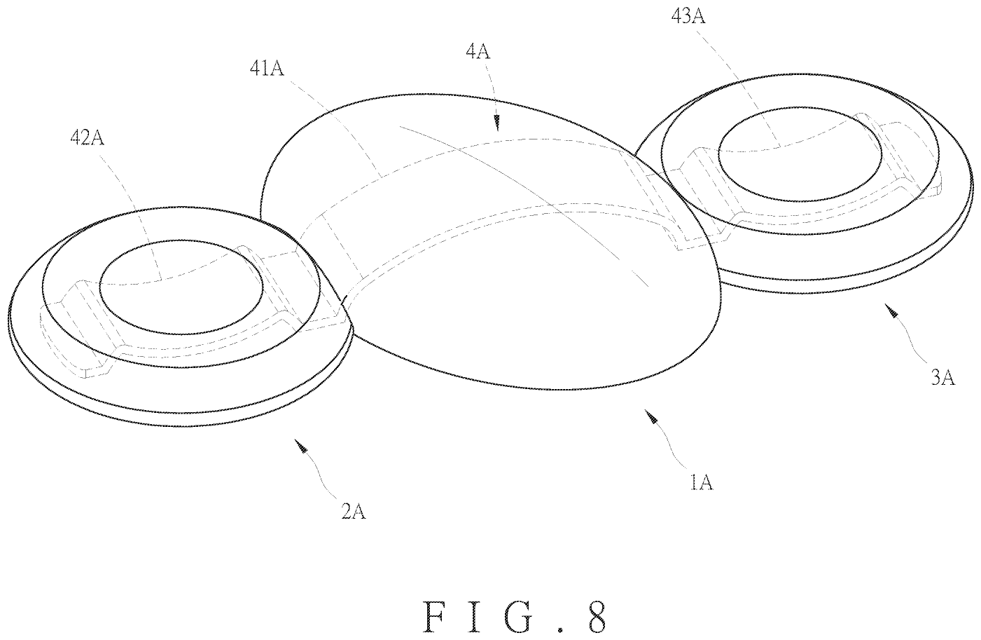

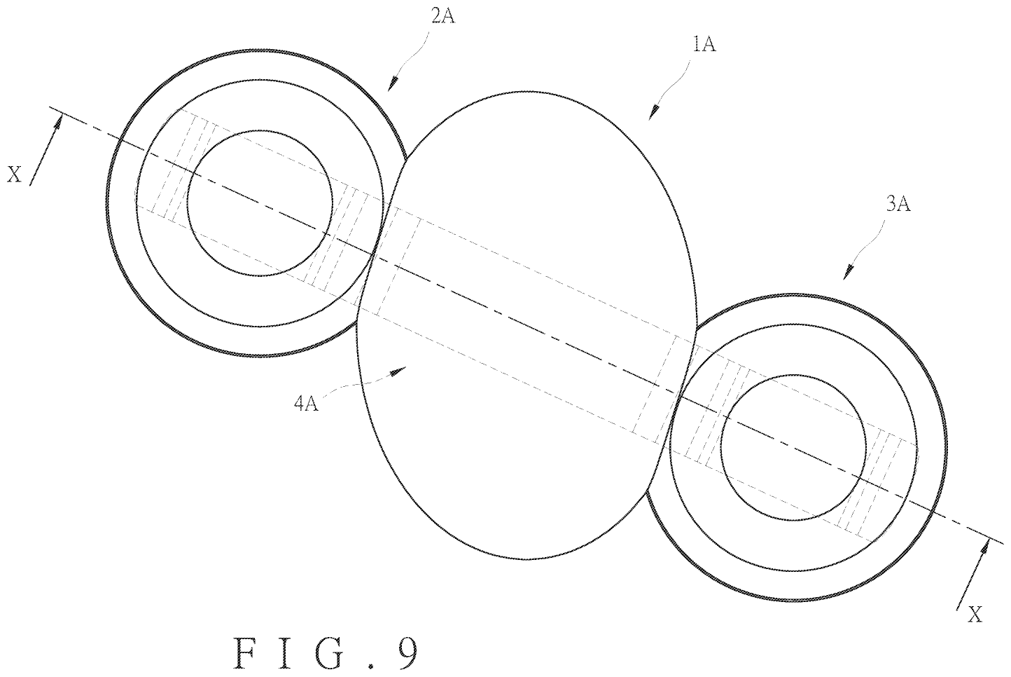

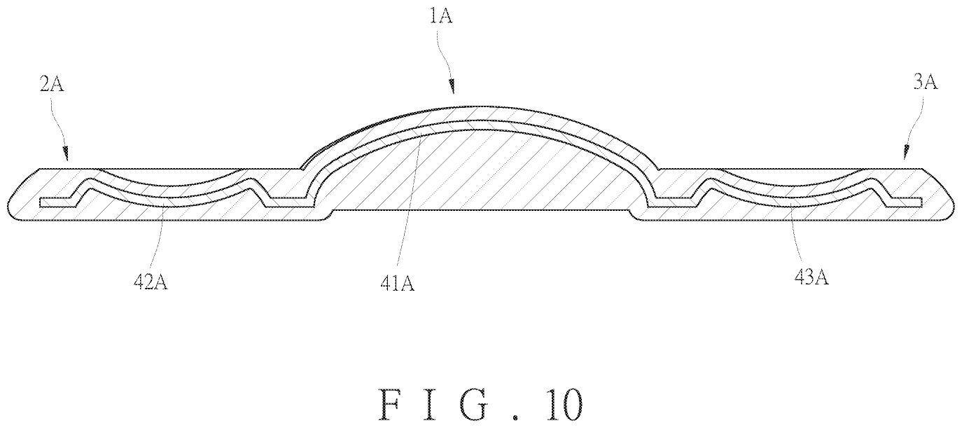

Referring to FIG. 8, FIG. 9, and FIG. 10, the second embodiment of the present invention includes a supporting portion 1A, an inner cushioning portion 2A, an outer cushioning portion 3A, and an elastic plate 4A.

The elastic plate 4A has an elastic-plate main body 41A. The two lateral sides of the elastic-plate main body 41A are extended with an inner wing plate 42A and an outer wing plate 43A respectively. The supporting portion 1A encloses the elastic-plate main body 41A. The inner cushioning portion 2A encloses the inner wing plate 42A. The outer cushioning portion 3A encloses the outer wing plate 43A. The elastic plate 4A has elasticity in the Z direction, and the supporting portion 1A has an allowable deformation thanks to this elasticity.

In addition, referring to FIG. 3 and FIG. 4, the lengths of the major axis 11 and minor axis 12 of the supporting portion 1 and the supporting-portion thickness 14; or the inner-cushioning-portion thickness 22, shape, or size of the inner cushioning portion 2; or the outer-cushioning-portion thickness 32, shape, or size of the outer cushioning portion 3; or the magnitudes of the first angle θ1 and the second angle θ2 can be customized according to the shape of a user's foot if necessary, so that the present invention can be comfortably and correctly used by adults and children of different genders.

The description of the foregoing embodiments should be able to enable a full understanding of the operation, use, and effects of the present invention. However, the embodiments described above are only some preferred ones of the invention and should not be construed as restrictive of the scope of the invention. Any simple equivalent changes or modifications made according to the appended claims and the disclosure of this specification shall fall within the scope of the invention.

What is claimed is:

1. A portable training device for plantar core muscles, configured for use by a human sole, wherein the sole has a transverse direction defined as an X direction and a longitudinal direction defined as a Y direction, a Z direction is perpendicular to both the X direction and the Y direction, the sole comprises a first metatarsophalangeal joint, a fifth metatarsophalangeal joint, and a heel, a transverse arch of the sole is defined between the first metatarsophalangeal joint and the fifth metatarsophalangeal joint, and a longitudinal arch of the sole is defined between the first metatarsophalangeal joint and the heel, the portable training device for plantar core muscles comprising:
a supporting portion configured to be disposed at a position corresponding to the transverse arch, wherein the supporting portion has a supporting-portion thickness in the Z direction, and the supporting portion has an allowable deformation in the Z direction;
an inner cushioning portion connected to the supporting portion, wherein the inner cushioning portion is configured to be disposed at a position corresponding to the first metatarsophalangeal joint, and the inner cushioning portion has an inner-cushioning-portion thickness in the Z direction; and
an outer cushioning portion connected to the supporting portion, wherein the outer cushioning portion is configured to be disposed at a position corresponding to the fifth metatarsophalangeal joint, the outer cushioning portion has an outer-cushioning-portion thickness in the Z direction, and the supporting-portion thickness is greater than the inner-cushioning-portion thickness and the outer-cushioning-portion thickness;
wherein when the portable training device for plantar core muscles is stepped on with the sole, the supporting portion supports the transverse arch to help train the longitudinal arch to arch naturally, thereby guiding plantar core muscles of the sole into contraction to strengthen the plantar core muscles.

2. The portable training device for plantar core muscles as claimed in claim 1, wherein the allowable deformation is one third to one half of the supporting-portion thickness.

3. The portable training device for plantar core muscles as claimed in claim 1, wherein the supporting portion comprises a supporting-portion upper surface, the supporting-portion upper surface is configured to contact the transverse arch, and the supporting-portion upper surface is a curved surface corresponding to the transverse arch.

4. The portable training device for plantar core muscles as claimed in claim 1, wherein the supporting portion has a major axis defining a greatest length of the supporting portion in the Y direction, the supporting portion further has a minor axis defining a greatest length of the supporting portion in the X direction, and the major axis has a greater length than the minor axis.

5. The portable training device for plantar core muscles as claimed in claim 4, wherein the major axis and the Y direction form a first angle, and the first angle is in the range from −15 degrees to +15 degrees; and wherein the inner cushioning portion has an inner-cushioning-portion geometric center, the outer cushioning portion has an outer-cushioning-portion geometric center, a line connecting the outer-cushioning-portion geometric center and the inner-cushioning-portion geometric center is defined as a geometric center connecting line, the geometric center connecting line and the X direction form a second angle, and the second angle is in the range from 15 degrees to 35 degrees.

6. The portable training device for plantar core muscles as claimed in claim 1, wherein the inner cushioning portion has an inner-cushioning-portion upper surface, and the inner-cushioning-portion upper surface is concave.

7. The portable training device for plantar core muscles as claimed in claim 6, wherein the inner cushioning portion is circular and is provided with a plurality of annular portions of different diameters, and the annular portions are arranged at intervals along a radial direction.

8. The portable training device for plantar core muscles as claimed in claim 1, wherein the outer cushioning portion has an outer-cushioning-portion upper surface, and the outer-cushioning-portion upper surface is concave.

9. The portable training device for plantar core muscles as claimed in claim 8, wherein the outer cushioning portion is circular and is provided with a plurality of annular portions of different diameters, and the annular portions are arranged at intervals along a radial direction.

10. The portable training device for plantar core muscles as claimed in claim 4, wherein the length of the major axis is in the range from 25 mm to 60 mm, the length of the minor axis is in the range from 15 mm to 40 mm, the inner-cushioning-portion thickness is in the range from 5 mm to 10 mm, the outer-cushioning-portion thickness is in the range from 5 mm to 10 mm, the supporting-portion thickness is in the range from 12 mm to 20 mm, outermost edges of the inner cushioning portion and of the outer cushioning portion in the X direction define a width of 40 mm to 120 mm in the X direction, and outermost edges of the inner cushioning portion and of the outer cushioning portion in the Y direction define a length of 30 mm to 80 mm in the Y direction.

11. The portable training device for plantar core muscles as claimed in claim 1, further comprising an elastic plate, wherein the elastic plate has an elastic-plate main body, the supporting portion encloses the elastic-plate main body, the elastic plate has elasticity in the Z direction, and the allowable deformation of the supporting portion is made possible by the elasticity.

12. The portable training device for plantar core muscles as claimed in claim 11, wherein the elastic-plate main body has two lateral sides extended with an inner wing plate and an outer wing plate respectively, the inner cushioning portion encloses the inner wing plate, and the outer cushioning portion encloses the outer wing plate.
